(19) United States
(12) Patent Application Publication
(10) Pub. No.: US 2017/0177181 A1
(43) Pub. Date: Jun. 22, 2017

(54) USER INTERFACE ANALYSIS AND MANAGEMENT

(71) Applicant: Facebook, Inc., Menlo Park, CA (US)

(72) Inventor: Arnold Joseph Noronha, Jersey City, NJ (US)

(21) Appl. No.: 14/974,474

(22) Filed: Dec. 18, 2015

(51) Int. Cl. G06F 3/0484; G06F 3/0481; H04L 12/26; G06T 7/00

(52) U.S. Cl. CPC G06F 3/0484; G06T 7/0022; G06F 3/0481; H04L 43/045

(57) ABSTRACT

Embodiments are disclosed for managing visual presentations of a user interface that involves multiple content providers. The present disclosure identifies a target section of the user interface associated with a target content provider who is responsible for providing a target content to be visually presented in the target section. The target content can be independently maintained or updated by the target content provider. The present disclosure can periodically generate, for example, visual presentations of the user interface based on the target content. The generated visual presentations of the user interface are then analyzed and the result of the analysis is transmitted to the target content provider. By doing so, the target content provider can effectively and efficiently manage the visual presentation of the target content in the user interface.

### BACKGROUND

An online content provider, such as an advertisement provider, usually wants its content to be visually presented in a specific way that is designed to attract more user attention. The online content provider may design a specific presentation that could lead to a satisfying user experience or achieve certain purposes that the content provider desires. Therefore, the way that an online user interface actually presents the content really matters to the online content provider.

For example, an online content provider may purchase a right to present its content on a web page (e.g., a social network web page) from a web service provider. For various reasons (e.g., brand imaging or visual stimulation concerns), the content provider may want to present its content in a specific way (e.g., displaying the content at the upper-right corner with a specific size, aspect ratio, specific shading/color, etc.). However, due to the compatibility challenges on hardware/firmware/software associated with the web service provider and the content provider (e.g., they may not use compatible hardware/firmware/software), the content that is visually presented to end users (e.g., online customers) may not be exactly the same as what the online content provider expected. This difference may cause certain problems and/or confusions and can defeat, or at least undermine, the purpose of having the online content provider's expected visual presentation.

### BRIEF DESCRIPTION OF THE DRAWINGS

Embodiments disclosed herein may be better understood by referring to the following Detailed Description in conjunction with the accompanying drawings.

FIG. 1 is a block diagram illustrating a system for managing a user interface in accordance with various embodiments of the present disclosure.

FIG. 2 is a block diagram illustrating another system for managing a user interface in accordance with various embodiments of the present disclosure.

FIG. 3 is a block diagram illustrating a user interface in accordance with various embodiments of the present disclosure.

FIG. 4 is a flow diagram illustrating a routine for implementing a method of managing a user interface in accordance with various embodiments of the present disclosure.

### DETAILED DESCRIPTION

Embodiments are disclosed for efficiently and effectively managing visual presentations of user interfaces. More particularly, a method and associated systems for efficiently and effectively managing visual presentations of a user interface that involves multiple content providers is disclosed. For a user interface operated under an open source operating system (e.g., Android™), multiple content providers (e.g., a social network that provides a framework of the user interface and an app developer that provides content to be presented in the user interface) can work separately, generate their individual contents, and then consolidate the generated contents. The consolidated contents will then be visually presented to online users in the user interface. The multiple content providers can use different emulators when generating and testing their contents. An emulator can be a specifically designed hardware/firmware/software that enables a host system to perform instructions in, or to use peripheral devices designed for, a remote system. Also, some of the content providers may update their responsible contents (e.g., an app developer may revise and update the appearance of the visual presentation of its app icon that is designed to be shown at a particular area of the user interface of a social network website) from time to time. As a result, it is difficult and challenging to effectively and efficiently manage the overall visual presentations of such a user interface.

The method of the present technology includes identifying a first section of a user interface and identifying a second section of the user interface. The first section is associated with a first content provider, and the second section is associated with a second content provider. In some embodiments, for example, the first content provider can be an online game app developer, and the second content provider can be an online advertiser. In some embodiments, the first section can be a virtual area of the user interface that has been assigned (e.g., purchased by the first content provider) to the first content provider for displaying an icon that is linked to his/her online app game server. Similarly, for example, the second section can be another virtual area of the user interface that has been assigned to the second content provider for displaying an advertising item (e.g., a video clip or a set of images). In some embodiments, the first content provider is responsible for providing and updating a first content that is to be visually presented to online users in the first section. In some embodiments, the second content provider is responsible for only providing (but not updating) a second content that is to be visually presented to online users in the second section. The first content provider uses a first emulator to create, analyze, test, and/or update the first content. In some embodiments, the first user can use a different type of emulator to update the first content. The second content provider uses a second emulator to create, analyze, and/or test the second content.

The method further includes, after receiving the first content and the second content, generating a first visual presentation (e.g., an image such as a screenshot or a set of images such as a video clip, an animation file, or a set of dynamic pictures) of the user interface based on the first content and the second content. The first visual presentation of the user interface can then be transmitted to the first content provider and the second content provider, and the first and second content providers can verify whether the first visual presentation of the user interface meets their expectations.

The method further includes generating a second visual presentation of the user interface based on updated first and second contents under some predetermined conditions. For example, the system can start to generate the second visual presentation of the user interface after a period of time (e.g., one day) counting from the generation of the first visual presentation of the user interface. As another example, the system can generate the second visual presentation of the user interface in response to several events. Examples of these events include receiving a request from one of the content providers, detecting a change of content in the first or second section of the user interface, etc.

In some embodiments, when the system decides to initiate the process of generating the second visual presentation of the user interface, the system can start to retrieve the updated first content from the first content provider and to retrieve the updated second content from the second content provider. If either the first content provider or the second provider fails to provide the updated content, the system can either (1) use the most current content or (2) update the content based on a set of predetermined rules (e.g., update a time displayed on an icon with a current time).

In other embodiments, the system can receive the updated first content from the first content provider and the updated second content from the second content provider periodically. In such embodiments, the system can generate the second visual presentation of the user interface based on the updated first and second contents shortly after receiving these updated contents.

The system then analyzes (or compares) the first visual presentation and the second visual presentation (e.g., by a pixel-to-pixel comparison) and generates an analysis result (or a comparison result). In some embodiments, the analysis result can be an image (or a set of images) illustrating the differences between the first visual presentation and the second visual presentation. In other embodiments, the analysis result can be a list, a summary, a description, etc., that indicates the differences between the first visual presentation and the second visual presentation. The system can then transmit the analysis result to the first content provider and the second content provider, such that the first and second content providers can verify whether the second visual presentation (e.g., the most current one) of the user interface meets their expectations. By doing so, the system enables a system operator and the first and second content providers to efficiently and effectively manage the contents to be presented in the user interface.

One aspect of the present disclosure is to provide a method and associated systems for dynamically verifying a visual presentation of a user interface. The method includes (1) identifying a target section of the user interface that is associated with a target content provider (the target content provider is responsible for providing a target content to be visually presented in the target section); (2) generating a first visual presentation of the user interface based on the target content; (3) transmitting the first visual presentation to the target content provider; (4) generating, after a predetermined time period from the generation of the first visual presentation, a second visual presentation of the user interface based on an updated target content; (5) analyzing the first visual presentation and the second visual presentation so as to generate an analysis result; and (6) transmitting the analysis result to the target content provider. Accordingly, a system operator and the target content provider can dynamically manage the visual presentation of the user interface.

Another aspect of the present disclosure is to provide a system for managing an integrated user interface. The integrated user interface can include more than two sections that are associated with different content providers. The system can include (1) a communication component configured to communicate with a target content provider; (2) a monitoring component configured to monitor a status of a target content provided by the target content provider; (3) a user interface simulation component configured to generate two visual presentations of the user interface based on a change of the status of the target content; and (4) an analysis component configured to analyze the generated multiple visual presentations so as to generate an analysis result. The analysis result is transmitted to the target content provider by the communication component such that a system operator and the target content provider can effectively and efficiently manage the integrated user interface.

In the foregoing and following descriptions, although the visual presentation of the user interface is analyzed in various embodiments, it is to be understood that other aspects (e.g., audio presentation or tactile presentation such as vibration) of the user interface can also be analyzed. Several embodiments of the described technology are described in more detail in reference to the Figures. The system or computing devices on which the described technology may be implemented may include one or more central processing units, memory, input devices (e.g., keyboard and pointing devices), output devices (e.g., display devices), storage devices (e.g., disk drives), and network devices (e.g., network interfaces). The memory and storage devices are computer-readable storage media that may store instructions that implement at least portions of the described technology. In addition, the data structures and message structures may be stored or transmitted via a data transmission medium, such as a signal on a communications link. Various communications links may be used, such as the Internet, a local area network, a wide area network, or a point-to-point dial-up connection. Thus, computer-readable media can comprise computer-readable storage media (e.g., “non-transitory” media) and computer-readable transmission media.

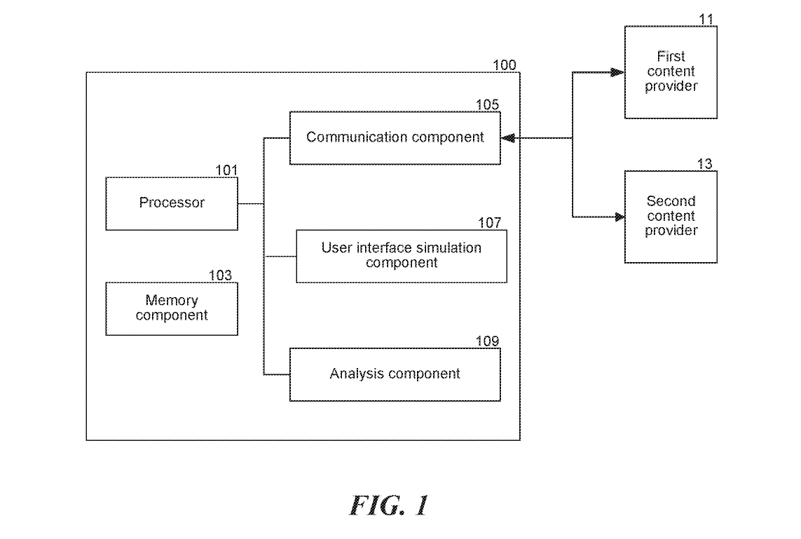

Several embodiments are described in more detail in reference to FIGS. 1-4. FIG. 1 is a block diagram illustrating a system 100 for managing a user interface in accordance with various embodiments of the present disclosure. As shown in FIG. 1, the system 100 includes a processor 101, a memory component 103, a communication component 105, a user interface simulation component 107, and an analysis component 109. The processor 101 is coupled to other components and configured to control the same in the system 100. The memory component 103 is configured to temporarily store data to be processed and/or intermediate results during operation. The system 100 can communicate, through the communication component 105, with a first content provider 11 and a second content provider 13. In other embodiments, the system 100 can communicate with more than two content providers. In some embodiments, the system 100 can communicate with the content providers through a wired or wireless network such as the Internet or a corporate intranet.

A content provider provides a specific content to the system 100 that is designated to be presented to a user (e.g., an online customer) through a user interface managed and maintained by the system 100. Examples of the specific content include an icon, an image, a picture, an animation, a video clip, a text, a link, a banner, a computer-implementable item, etc. For example, the specific content can be an icon associated with a link directed to an online service (e.g., games, shopping, news feeds, data archives, location/map services, advertisements, other suitable services, etc.). When a user views the icon in the user interface (e.g., via a web browser) and then interacts (e.g., clicks) the icon, the user will be directed to a web page associated with that online service. The visual appearance of the specific content is very important to the content provider because it is designed to attract the user's attention.

In the illustrated embodiment, the system 100 is operated under an open source operating system (e.g., Android™, Linux, FreeBSD, OpenBSD, etc.) associated with multiple emulators that can be used to enable a remote system (e.g., a computer system used by the first content provider 11 or the second content provider 13) to emulate or simulate the system 100 (such that the first content provider 11 or the second content provider 13 can have an idea of how a specific content will be visually presented by the system 100). In the illustrated embodiment, the first content provider 11 creates a first content by using a first emulator and then provides the first content to the system 100. The second content provider 13 creates a second content by using a second emulator and then provides the second content to the system 100. Sometimes, an emulator cannot perfectly emulate or simulate a system due to various reasons (e.g., system configurations, network settings, hardware/firmware/software compatibilities, etc.). Therefore, it is important for the system 100 to ensure that the first content and the second content are properly presented (e.g., as the first content provider 11 and the second content provider 13 expected) in the user interface. The foregoing task can be performed by the user interface simulation component 107 and the analysis component 109, discussed in detail below.

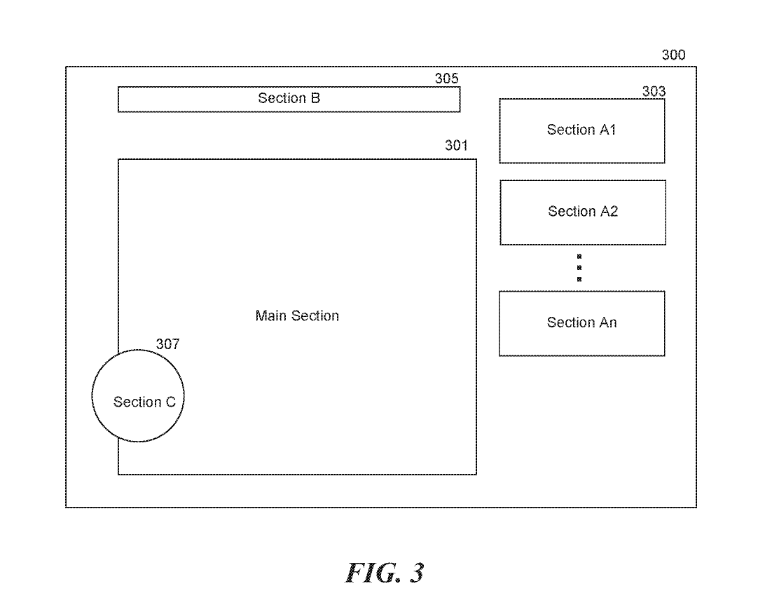

The user interface simulation component 107 is configured to generate visual presentations of the user interface (e.g., a screenshot of the user interface) that includes the provided first and second contents. The visual presentations are generated at least based on the following factors: (1) the first and second contents; (2) a basic framework of the user interface; (3) the relative locations/sizes/shapes/colors of the first and second contents to be presented in the user interface (e.g., the first content provider 11 and the second content provider 13 can have prior agreements with an operator of the system 100 about the relative locations/sizes/shapes/colors); and (4) other suitable user configurations. Embodiments of the user interface will be further discussed in detail below with reference to FIG. 3.

In the illustrated embodiment in FIG. 1, the user interface simulation component 107 generates a first visual presentation shortly after receiving the first and second contents. In some embodiments, after a certain period of time (e.g., an hour, a day, a week, etc.), the system 100 can generate a second visual presentation based on the most current received first and second contents. In other embodiments, the second visual presentation can be generated after a determination that the first content or second content has been updated. In some embodiments, the determination can be done by having the system 100 constantly monitor the received first and second contents. In other embodiments, the determination can be done by receiving an update notification from either the first content provider 11 or the second content provider 13.

In some embodiments, the first and second visual presentations can be generated without using an emulator. In other embodiments, the first and second visual presentations can be generated by an emulator. In such embodiments, the first and second visual presentations can be generated by one of the emulators used by the first and second content providers. In some embodiments, the first and second visual presentations can have multiple versions corresponding to different online web browsers (e.g., what the user interface looks like via a first web browser may be different from what it looks like via a second web browser).

After the second visual presentation is generated, the analysis component 109 analyzes the first and second visual presentations and accordingly generates an analysis result. In the illustrated embodiment, analyzing the first and second visual presentations includes having a pixel-by-pixel analysis of the visual presentations. In other embodiments, analyzing the visual presentations can be any suitable image-based analysis (e.g., suitable brightness, color, graphic analyses, etc.). The analysis result can include the differences between the two visual presentations (if any). The differences can be marked in one of the two visual presentations or listed in a table with suitable descriptions (e.g., a description such as “the font of the first content has been changed,” “strong brightness contrast: from pixel A to pixel B,” or “significant color changes: from pixel C to pixel D”). The analysis result can also include other suitable information such as when the analysis was performed.

The system 100 then transmits, through the communication component 105, the analysis result to the first content provider 11 and the second content provider 13. The first content provider 11 and the second content provider 13 can verify whether the first content and the second content are visually presented in the way they expected. If so, in some embodiments, the first content provider 11 and the second content provider 13 can send a confirmation to the system 100. If not, in some embodiments, the first content provider 11 or the second content provider 13 can send a request for correction to the system 100. By doing so, the system 100 provides the first content provider 11 and the second content provider 13 opportunities to effectively and efficiently manage the visual appearance of their contents to be presented.

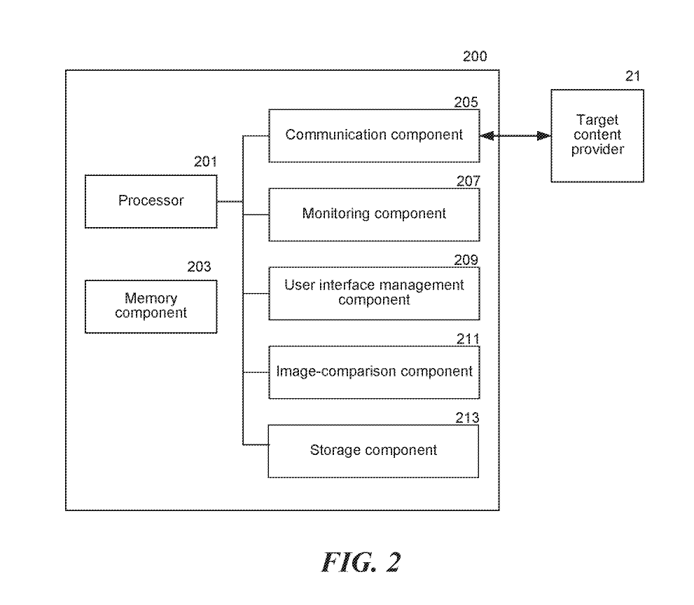

FIG. 2 is a block diagram illustrating a system 200 for managing a user interface in accordance with various embodiments of the present disclosure. As shown in FIG. 2, the system 200 includes a processor 201, a memory component 203, a communication component 205, a monitoring component 207, a user interface management component 209, an image-comparison component 211, and a storage component 213. The processor 201 is coupled to other components and configured to control the same in the system 200. The memory component 203 is configured to temporarily store data to be processed and/or intermediate results during operation. The system 200 can communicate, through the communication component 205, with a target content provider 21. In other embodiments, the system 200 can communicate with two or more target content providers. In some embodiments, the system 200 can communicate with the target content provider 21 through a wired or wireless network.

The system 200 can first identify a target section of the user interface managed by the system 200. The target section can be determined by relative locations in the user interface (e.g., the upper-right corner) or other suitable factors (e.g., all virtual spaces assigned or sold to the target content provider 21). Once the target section is identified, the monitoring component 207 can constantly monitor a target content associated with the target section and provided by the target content provider 21. In some embodiments, monitoring the target content can include periodically accessing a database associated with the target content provider 21 to see if there is any update for the target content. In other embodiments, monitoring the target content can include periodically accessing a database managed by the system 200 (e.g., the storage component 213) that the target content provider 21 is authorized to access (e.g., to upload an update of the target content thereto).

The user interface management component 209 is configured to generate visual presentations of the user interface (e.g., a screenshot of the user interface) that includes the target contents. The user interface management component 209 is also configured to manage the target contents that are received or retrieved at different time points (e.g., the target content can be updated daily or weekly). The user interface management component 209 is also configured to store these target contents in the storage component 213. Upon request or based on a predetermined routine (e.g., daily or weekly), the user interface management component 209 can generate visual presentations of the target content. The visual presentations are generated at least based on the following factors: (1) the received or retrieved target contents; (2) a basic framework of the user interface; (3) the relative locations/sizes/shapes/colors of the target contents to be shown in the user interface (e.g., the target section); and (4) other suitable user configurations. Embodiments of the user interface will be further discussed in detail below with reference to FIG. 3.

In the illustrated embodiment, the user interface management component 209 can generate a first visual presentation based on the target content received or retrieved at a first time point and a second visual presentation based on the target content received or retrieved at a second time point. In other embodiments, the second visual presentation can be generated after a determination that the target content has been updated. After the first and second visual presentations are generated, the image-comparison component 211 compares the first and second visual presentations and accordingly generates a comparison result. In the illustrated embodiment, comparing the first and second visual presentations includes having a pixel-by-pixel comparison of the visual presentations. In other embodiments, comparing the visual presentations can be any suitable image-based comparison. The comparison result can include the differences between the two visual presentations. The differences can be marked in one of the two visual presentations or listed in a table with suitable descriptions. The comparison result can also include other suitable information such as when the comparison was performed.

The system 200 then transmits, through the communication component 205, the comparison result to the target content provider 21. The target content provider 21 can then verify whether the target content is visually presented as expected. If so, in some embodiments, the target content provider 21 can send a confirmation to the system 200. If not, in some embodiments, the target content provider 21 can send a request for correction to the system 200. By doing so, the system 200 provides the target content provider 21 opportunities to effectively and efficiently manage the visual appearance of the target content to be presented. In some embodiments, all generated visual presentations (e.g., the first and second visual presentations) and the comparison results can be stored in the storage component 213 for future reference or analysis.

FIG. 3 is a block diagram illustrating a user interface 300 in accordance with various embodiments of the present disclosure. The user interface 300 can be visually presented by a display when a user accesses the user interface 300 via a web browser. As shown in FIG. 3, the user interface 300 includes a main section 301, multiple sections A1-An 303, a section B 305, and a section C 307. In the illustrated embodiment, the user interface 300 can be managed by a social network. The main section 301 is configured to present contents from the social network (e.g., a user profile including the user's basic information and his/her posts).

In the illustrated embodiment, the sections A1-An 303 are configured to present contents from one or more first type content providers. For example, the first type content provider can be an app developer. In such embodiments, the sections A1-An 303 can be assigned to different app developers that provide various online services.

In the illustrated embodiment, the section B 305 can be assigned to a second type content provider. For example, the second type content provider can be an online-search service provider. In such embodiments, the content to be visually presented in the section B 305 can be a search toolbar. In the illustrated embodiment, the section C 307 can be assigned to a third type content provider. For example, the third type content provider can be an advertiser. In such embodiments, the content to be visually presented in the section C 307 can be an advertisement. In some embodiments, the section C 307 can be a dynamic section that can move across the user interface 300 (e.g., it can move randomly to draw attention when a user is accessing the user interface 300). In other embodiments, the user interface 300 can have other arrangements (e.g., have sections with different shapes, sizes, locations, movements, etc.).

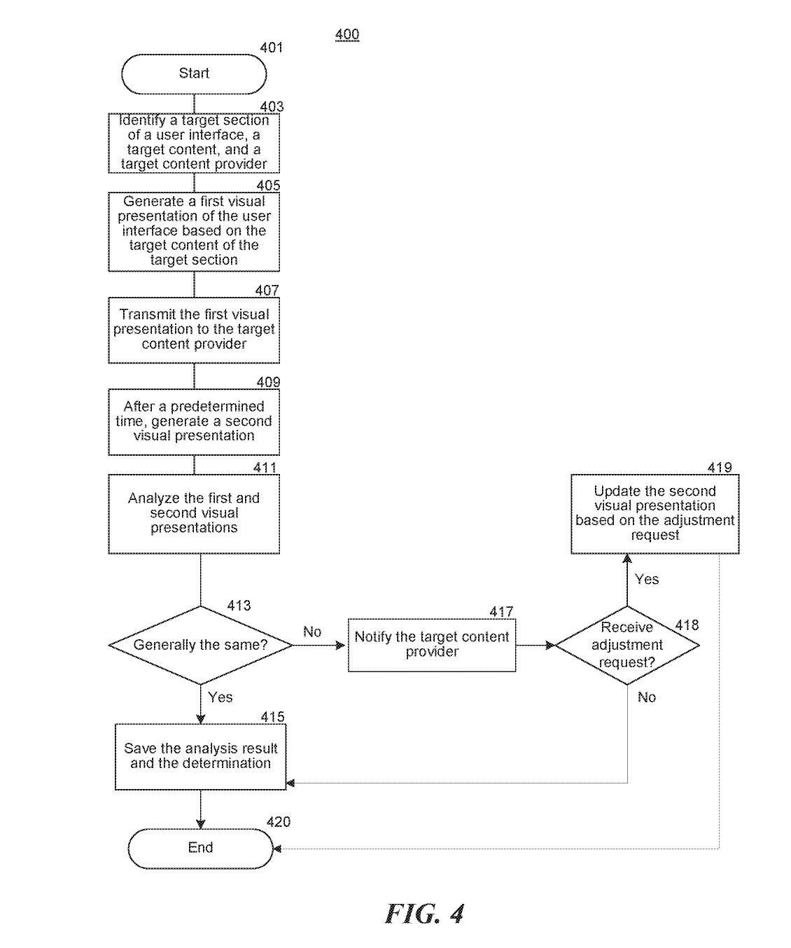

FIG. 4 is a flow diagram illustrating a routine 400 for implementing a method of managing a user interface in accordance with various embodiments of the present disclosure. The routine 400 can be used to manage visual presentations of the user interface managed by a system in accordance with the present disclosure. The system can initial the routine 400 at block 401. The routine 400 proceeds to block 403 and identifies a target section of the user interface, a target content, and a target content provider. At block 405, the system can generate a first visual presentation of the user interface based on the target content of the target section.

At block 407, the system can transmit the first visual presentation to the target content provider. At block 409, the system can generate, after a predetermined time, a second visual presentation of the user interface based on an updated target content. The system can then analyze the first and second visual presentations at block 411. The routine 400 then moves to a decision block 413 to determine whether the first and second visual presentations are generally the same. If so, then, at block 415, the system saves the analysis result and the determination (made at block 413). Then the routine 400 ends at block 420.

If not, at block 417, the system notifies the target content provider that the first and second visual presentations are not generally the same, which signifies that the target content has been changed. The routine 400 then moves to a decision block 418 to determine whether the system has received an adjustment request from the target content provider after sending out the above-mentioned notification (e.g., after a predetermined waiting period such as one day). If so, at block 419, the system updates the second visual presentation based on the adjustment request and then the routine 400 ends at block 420. If not, which means that the system has not received any adjustment request after the predetermined waiting period, the system will assume that the target content provider does not want to make any adjustment in response to the notification. The routine 400 then ends at block 420.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims. Accordingly, the present disclosure is not limited except as by the appended claims.

I/We claim:

1. A method for performing a test of a user interface, the method comprising:
identifying a first section of the user interface, the first section being associated with a first content provider, wherein the first content provider provides a first content to be visually presented in the first section, and wherein the first content is associated with a first emulator;
identifying a second section of the user interface, the second section being associated with a second content provider, wherein the second content provider provides a second content to be visually presented in the second section, and wherein the second content is associated with a second emulator;
generating a first visual presentation of the user interface based on the first content and the second content;
receiving a first updated content from the first content provider;
receiving a second updated content from the second content provider;
generating a second visual presentation of the user interface based on the first updated content and the second updated content;
analyzing the first visual presentation and the second visual presentation so as to generate an analysis result; and
transmitting the analysis result to the first content provider and the second content provider.

2. The method of claim 1, further comprising identifying a difference between the first visual presentation and the second visual presentation.

3. The method of claim 2, wherein the difference is identified based on an image-based comparison.

4. The method of claim 2, wherein the difference is identified based on a pixel-to-pixel comparison.

5. The method of claim 1, wherein the analysis result includes an indication that the first visual presentation and the second visual presentation are generally the same.

6. The method of claim 1, wherein the analysis result includes a first analysis result associated with the first content and a second analysis result associated with the second content, and wherein transmitting the analysis result to the first content provider and the second content provider includes transmitting the first analysis result to the first content provider and transmitting the second analysis result to the second content provider.

7. The method of claim 1, further comprising receiving a request to adjust the second visual presentation from one of the first content provider and the second content provider.

8. The method of claim 1, wherein the first and second visual presentations are screenshots of the user interface.

9. The method of claim 8, wherein the screenshots are generated based on an end-user configuration.

10. The method of claim 1, wherein the first emulator and the second emulator are associated with an open source operating system.

11. A method for dynamically verifying a visual presentation of a user interface, the method comprising:
identifying a target section of the user interface, the target section being associated with a target content provider, wherein the target content provider provides a target content to be visually presented in the target section, and wherein the target content is dynamically maintained by the target content provider;
generating a first visual presentation of the user interface based on the target content;
transmitting the first visual presentation to the target content provider;
generating, after a predetermined time period from the generation of the first visual presentation, a second visual presentation of the user interface based on the target content;
analyzing the first visual presentation and the second visual presentation so as to generate an analysis result; and
transmitting the analysis result to the target content provider.

12. The method of claim 11, further comprising identifying a difference between the first visual presentation and the second visual presentation.

13. The method of claim 12, wherein the difference is identified based on an image-based comparison.

14. The method of claim 12, wherein the difference is identified based on a pixel-to-pixel comparison.

15. The method of claim 11, wherein the analysis result includes an indication that the first visual presentation and the second visual presentation are generally the same.

16. The method of claim 11, further comprising receiving a request to adjust the second visual presentation from the target content provider.

17. The method of claim 11, wherein the first and second visual presentations are screenshots of the user interface.

18. The method of claim 17, wherein the screenshots are generated based on an end-user configuration.

19. The method of claim 11, wherein the target content is associated with an emulator compatible with an open source operating system.

20. A system for managing an integrated user interface, comprising:
a processor;
a memory component coupled to the processor;
a communication component coupled to the processor and configured to communicate with a target content provider;
a monitoring component coupled to the processor and configured to monitor a status of a target content provided by the target content provider;
a user interface simulation component coupled to the processor and configured to generate two visual presentations of the user interface based on a change of the target content; and
an analysis component coupled to the processor and configured to analyze the generated multiple visual presentations so as to generate an analysis result, wherein the analysis result is transmitted to the target content provider by the communication component.

21. The system of claim 20, wherein the analysis result includes a difference between the two generated visual presentations.

22. The system of claim 21, wherein the difference is identified based on an image-based comparison.

23. The system of claim 21, wherein the difference is identified based on a pixel-to-pixel comparison.

24. The system of claim 20, wherein the analysis result includes an indication that the two generated visual presentations are generally the same.

25. The system of claim 20, wherein the two generated visual presentations are screenshots of the user interface.

26. The system of claim 25, wherein the screenshots are generated based on an end-user configuration.

27. The system of claim 25, wherein the target content is associated with an emulator compatible with an open source operating system.
